(19) United States
(12) Patent Application Publication
(10) Pub. No.: US 2020/0212508 A1
(43) Pub. Date: Jul. 2, 2020

(54) A LI-ION THIN FILM MICROBATTERY AND METHOD OF FABRICATING THE SAME

(71) Applicants: MASSACHUSETTS INSTITUTE OF TECHNOLOGY, Cambridge, MA (US); NATIONAL UNIVERSITY OF SINGAPORE, Singapore (SG)

(72) Inventors: Daniele PEREGO, Switzerland (CH); Rajamouly OMAMPULIYUR SWAMINATHAN, Singapore (SG); Ye Lin Thu (No Family Name), Singapore (SG); Shao-Horn YANG, Cambridge, MA (US); Wee Kiong CHOI, Singapore (SG); Carl Vernette THOMPSON, II, Cambridge, MA (US)

(73) Assignees: MASSACHUSETTS INSTITUTE OF TECHNOLOGY, Cambridge, MA (US); NATIONAL UNIVERSITY OF SINGAPORE, Singapore (SG)

(21) Appl. No.: 16/321,711

(22) PCT Filed: Jul. 28, 2017
(86) PCT No.: PCT/US2017/044351

§ 371 Date: Jan. 29, 2019

Related U.S. Application Data
(60) Provisional application No. 62/368,231, filed on Jul. 29, 2016.

(51) Int. Cl. H01M 10/42; H01M 10/0525; H01M 4/48; H01M 4/38; H01M 4/36

(52) U.S. Cl. CPC H01M 10/4257; H01M 10/0525; H01M 4/483; H01M 2010/4271; H01M 4/366; H01M 2220/30; H01M 2300/002; H01M 4/386

(57) ABSTRACT

A Li-ion thin film microbattery, a microbattery array, a method of fabricating a Li-ion thin film microbattery and a method of fabricating a microbattery array. The Li-ion thin film microbattery comprises a Li-free cathode comprising a transition metal oxide thin film; an anode comprising a lithiated Ge or Si thin film; and an electrolyte film disposed between the cathode and the anode; wherein a Li-source of the Li-ion thin film microbattery is provided by means of the lithiated Ge or Si thin film.

### CROSS-REFERENCE TO RELATED APPLICATION

This application claims the benefit of priority of U.S. Provisional Application No. 62/368,231 filed on Jul. 29, 2016, the content of which is incorporated herein by reference in its entirety for all purposes.

### TECHNICAL FIELD

This invention relates broadly to a Li-ion thin film microbattery and method of fabricating the same, and to a microbattery array and a method of fabricating the same.

### BACKGROUND

Technological advances in microelectronics have reduced the power requirements of electronic circuitry and micro-electro-mechanical systems, enabling the use of on-chip Li-ion thin film microbatteries for applications such as environmental sensing [1,2], RFID [3], smart cards [4], Internet of Things (IoT) [5], and even micro-spacecraft [6]. Many more applications can be made possible when microbatteries are directly integrated with electronic circuitry rather than placed separately on a printed circuit board (PCB).

Microbatteries can be fabricated using thin film technologies commonly used for manufacture of other microsystems [7,8]. Li-ion thin film microbatteries (TFMs) typically include a cathode comprising a Li-containing transition metal oxide or the like, an anode typically made by Lithium metal and a solid electrolyte made by Lithium Phosphorus Oxynitride (LiPON).

In order to meet the increasing demands on capacity and performance, new concepts for Li-ion microbatteries that can be manufactured in a simple manner are desirable. The critical issues inhibiting the large-scale commercial adoption of Li-ion microbatteries to-date are: (i) relatively low capacity of Li-containing cathode materials; (ii) safety concerns when using pure Li metal as the anode; (iii) reduced reliability when using high capacity anode (Si); and (iv) integrability with CMOS processes and platforms.

Embodiments of the present invention seek to address one or more of the above-mentioned needs.

### SUMMARY

In accordance with a first aspect of the present invention there is provided a Li-ion thin film microbattery comprising a Li-free cathode comprising a transition metal oxide thin film; an anode comprising a lithiated Ge or Si thin film; and an electrolyte film disposed between the cathode and the anode; wherein a Li-source of the Li-ion thin film microbattery is provided by means of the lithiated Ge or Si thin film.

In accordance with a second aspect of the present invention there is provided a microbattery array comprising two or more of the Li-ion thin film microbattery of the first aspect.

In accordance with a third aspect of the present invention there is provided a method of fabricating a Li-ion thin film microbattery, comprising the steps of providing a Li-free cathode comprising a transition metal oxide thin film; providing an anode comprising a lithiated Ge or Si thin film; and providing an electrolyte film disposed between the cathode and the anode; wherein a Li-source of the Li-ion thin film microbattery is provided by means of the lithiated Ge or Si thin film

In accordance with a fourth aspect of the present invention there is provided a method of fabricating a microbattery array, comprising fabricating two or more Li-ion thin film microbatteries using the method of the third aspect.

### BRIEF DESCRIPTION OF THE DRAWINGS

The invention will be better understood with reference to the detailed description when considered in conjunction with the non-limiting examples and the accompanying drawings, in which:

FIG. 1 shows a graph illustrating output voltage vs. volumetric specific capacity of RuO₂ thin film for use in example embodiments deposited in Ar and O₂ plasma environment.

FIG. 2 shows a graph illustrating comparative Ge vs Si areal specific capacity, for use in example embodiments.

FIG. 3(a) shows a field emission scanning electron microscopy (FE-SEM) top-view and cross-section (insert) images of an as-deposited RuOₓ thin film sputter deposited using a pure O₂ plasma, for use in example embodiments.

FIG. 3(b) shows a transmission electron microscopy (TEM) bright-field cross-section image and a selected area electron diffraction pattern (SAEDP) (insert) in a RuOₓ thin film deposited using a pure O₂ plasma, for use in example embodiments.

FIG. 4(a) shows cyclic voltammograms obtained at a scan rate 0.5 mV/s in 300 nm RuOₓ|LiPF₆|Li cells, with Li metal also used as a reference electrode, specifically 1^{st}-cycle for an as-deposited RuOₓ film sputter deposited using pure argon and pure oxygen, respectively, for use in example embodiments.

FIG. 4(b) shows cyclic voltammograms obtained at a scan rate 0.5 mV/s in 300 nm RuOₓ|LiPF₆|Li cells, with Li metal also used as a reference electrode, specifically 3^{rd} cycle for sputter deposited RuOx films made using pure argon and pure oxygen, respectively, for use in example embodiments.

FIG. 5(a) shows charge/discharge profiles for RuOₓ films (300 nm RuOₓ|LiPF₆|Li) characterized at a rate of 0.1 C at room temperature, voltage window: 0.75-3.5 V vs. Li/Li⁺, for use in example embodiments.

FIG. 5(b) shows a graph illustrating capacity retention for RuOₓ thin films at room temperature for use in example embodiments, the films sputter deposited using different Ar/O₂ gas mixtures.

FIG. 6 shows a graph illustrating volumetric specific capacity of RuOₓ thin films as a function of oxygen atomic stoichiometry, for use in example embodiments.

FIG. 7(a) shows a graph illustrating in-situ stress evolution of Ge anode for use in an example embodiment, during lithiation/delithiation.

FIG. 7(b) shows a graph illustrating in-situ stress evolution of Si anode for use in an example embodiment, during lithiation/delithiation.

FIG. 8 shows a graph illustrating rate performance of Si and Ge anodes for use in example embodiments.

FIG. 9(a) shows a schematic drawing illustrating bi-layer sputtered pre-lithiated anode for use in an example embodiment.

FIG. 9(b) shows a schematic drawing illustrating multi-layer sputtered pre-lithiated anode for use in an example embodiment.

FIG. 9(c) shows a schematic drawing illustrating co-sputtered pre-lithiated anode for use in an example embodiment.

FIG. 10(a) shows a schematic drawing illustrating microbattery integration with electronic circuitry through wafer-bonding according to an example embodiment, specifically electronic circuitry on Si substrate.

FIG. 10(b) shows a schematic drawing illustrating microbattery integration with electronic circuitry through wafer-bonding according to an example embodiment, specifically microbattery on Si substrate.

FIG. 10(c) shows a schematic drawing illustrating microbattery integration with electronic circuitry through wafer-bonding according to an example embodiment, specifically integrated stack.

FIG. 11(a) shows a schematic drawing illustrating direct deposition of microbattery according to an example embodiment, specifically microbattery on top of electronic circuitry.

FIG. 11(b) shows a schematic drawing illustrating direct deposition of microbattery according to an example embodiment, specifically microbattery on the back of the Si substrate.

FIG. 12(a) shows a schematic drawing illustrating a microbattery array according to an example embodiment, specifically a top-view schematic.

FIG. 12(b) shows a schematic drawing illustrating a microbattery array according to an example embodiment, specifically cross-section of a single microbattery of the microbattery array.

FIG. 12(c) shows an equivalent circuit of a microbattery array according to an example embodiment.

FIG. 13 shows a plot showing electrochemical performance of a proof-of-concept CMOS-integrable microbattery prototype example embodiment based on RuO₂ cathode, LiPON electrolyte, pre-lithiated Si anode.

FIG. 14a) shows a graph illustrating Si areal capacity as a function of charge/discharge cycle at different rate for different Si thicknesses, for use in example embodiments.

FIG. 14b) shows a graph illustrating Si relative areal capacity normalized to first charge/discharge cycle at different rate for different Si thicknesses, for use in example embodiments.

FIG. 15a) shows a graph illustrating Si/LiPON areal capacity as a function of charge/discharge cycle at different rate for different Si thicknesses, for use in example embodiments.

FIG. 15b) shows a graph illustrating Si/LiPON relative areal capacity normalized to first charge/discharge cycle at different rate for different Si thicknesses, for use in example embodiments.

FIG. 16a) shows graph illustrating Ge areal capacity as a function of charge/discharge cycle at different rate for different Ge thicknesses, for use in example embodiments.

FIG. 16b) shows a graph illustrating Ge relative areal capacity normalized to first charge/discharge cycle at different rate for different Ge thicknesses, for use in example embodiments.

FIG. 17a) shows a graph illustrating Ge/LiPON areal capacity as a function of charge/discharge cycle at different rate for different Ge thicknesses, for use in example embodiments.

FIG. 17b) shows a graph illustrating Ge/LiPON relative areal capacity normalized to first charge/discharge cycle at different rate for different Si thicknesses, for use in example embodiments.

FIG. 18 shows a flow chart illustrating a method of fabricating a Li-ion thin film microbattery, according to an example embodiment.

### DETAILED DESCRIPTION

Example embodiment of the present invention can provide for a Li-ion thin film microbattery that can be easily integrated into microelectronic or other microsystems fabrication processes.

Example embodiment of the present invention can provide for a high capacity cathode material (Li-free transition metal oxides such as V₂O₅, CrO₃, RuO₂) implementation into Li-ion microbatteries.

Example embodiment of the present invention can provide for a high capacity, improved cyclability and safety anode material (Si and Ge) implementation into Li-ion microbatteries.

Example embodiment of the present invention can provide for Li-source implementation (in the anode side) into Li-ion microbatteries (referred as pre-lithiation technique).

Example embodiment of the present invention can also provide new design and process fabrication for integrable Li-ion thin film microbattery arrays characterized by customizable output power and improved reliability.

In energy storage field, one of the key parameters widely used to compare different electrode active materials is gravimetric specific capacity measured by [mAh/g] or [Ah/Kg] metrics. However, microbatteries are restricted in terms of the amount of areal footprint the microbattery stack can occupy. Therefore, the areal specific capacity of electrodes is a far more important metric measured by [mAh/cm²] or [μAh/cm²] units. Moreover, since areal specific capacity is a function of the volumetric specific capacity, the key parameter in the Li-ion thin film microbatteries field is the volumetric specific capacity measured by rescaling the areal specific capacity over the thickness of the electrode [mAh/cm²μm] or [μAh/cm²μm].

Considering the volumetric specific capacity a list of possible cathode materials can be found in Table 1. Among them it is possible to identify two different classes: the first one made by cathodes containing Li in their stoichiometry while the second one is characterized by Li-free transition metal oxides cathode materials.

TABLE 1
Cathode material volumetric specific capacities [9]

| | Volumetric specific capacity |
|---|---|
| Cathode materials | [μAh/cm²μm] |
| LiCoO₂ | 63.7 |
| LiNiO₂ | 62.1 |
| LiMnO₂ | 64.5 |
| LiNi_{0.5}Mn_{0.5}O₂ | 65.1 |
| LiMn₂O₄ | 63.3 |
| LiFePO₄ | 61.2 |
| LiMnPO₄ | 73.7 |
| CrO₃ | 434.2 |
| V₂O₅ | 147.8 |
| RuO₂ | 561.8 |

The increasing demand on capacity might be solved by introducing Li-free transition metal oxide cathodes such as CrO₃, V₂O₅ and RuO₂ that are characterized by a very high volumetric specific capacity. A drawback of such cathodes is the absence of Li-ions within their structure, which makes them unusable in current state-of-the-art Li-ion microbatteries, where cathodes act as the Li-ion source. Indeed the state-of-the-art for Li-ion thin film microbattery cathode is typically restricted to LiMₓO_{y} stoichiometries where M is a transition metal such as Co, Mn, Ni or a mixture of transition metals). Li containing cathode materials act as the Li-source for the full microbattery, and in the first charge cycle the Li is transferred to the anode materials. The advantages of this family of materials are (i) good cyclability, (ii) safety, and (iii) reasonable rate performance. However, as a class, these materials have limited volumetric specific capacity for storage of Li (the highest is LiNi_{0.5}Mn_{0.5}O₂˜65.1 μAh/cm²μm). To this stage the overall energy capacity of a microbattery is generally limited by the capacity of the cathode, as higher capacity anode materials are available and implemented.

In example embodiments of the present invention, Li-free transition metal oxides are instead implemented as cathode active materials for Li-ion thin film microbatteries. For example RuO₂ is characterized by a very high volumetric specific capacity [561.8 μAh/cm²μm], due to its ability to incorporate up to 4 mol Li atoms per mol of RuO₂ during the discharge phase via the following reaction:

RuO₂+4e⁻+4Li⁺→Ru+2Li₂O

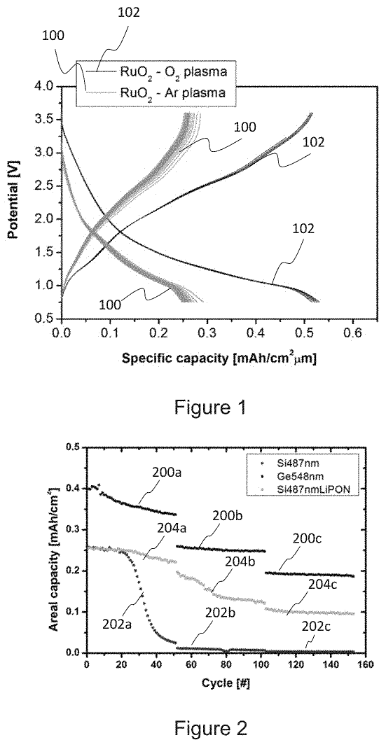

RuO₂ thin film can be deposited through a variety of techniques such as, but not limited to: chemical vapor deposition, electrodeposition, physical vapor deposition. In example embodiments sputtering deposition of a RuO₂ target in Ar, O₂ and a mixture Ar:O₂ plasma environment is used. Electrochemical performance of as synthesized RuO₂ thin film in Ar (curves 100) and O₂ (curves 102) are shown in FIG. 1.

RuO₂ can provide an overall volumetric specific energy of about 1014.2 mWh/cm²μm, which is 5 times greater with respect to the state-of-the-art LiCoO₂ volumetric specific energy (248.5 mWh/cm²μm). While Li-free transition metal oxide cathodes have a relatively large voltage dispersion as a function of charge state (i.e. the absence of a voltage plateau), with respect to state-of-the-art (LiCoO₂ and LiFePO₄), this can preferably be addressed in example embodiments by developing an integrated/CMOS compatible fabrication process and/or the fabrication of a Li-ion thin film microbatteries array, as will be described in more detail below. The output voltage and power can be appropriately fine-tuned in example embodiment by integrating the microbattery with a suitable CMOS driver circuit such as amplifiers and/or by coupling different Li-ion thin film microbatteries in an array.

### Substrate Preparation for Transition Metal Oxide, such as, but Not Limited to, RuO, Thin Films for Use in Example Embodiments

RuOₓ thin films were deposited on several types of substrates, including stainless steel (SS) discs, and Ti/Pd layers deposited on SiO₂-coated Si wafers. Deposition of RuOₓ layers on Ti/Pd films on oxidized Si wafers were well suited for scanning electron microscopy (SEM), transmission electron microscopy (TEM) and x-ray diffraction (XRD) characterization. Electrochemical performance was investigated using SS discs, which acted both as current collectors and non-reactive substrates. SS discs of 1.2 cm in diameter and 0.5 mm in thickness were cut from an AISI 316 L sheet and mechanically polished to create a mirror-like smooth surface, avoiding roughness effects on the electrochemical characterization. The mechanical polishing involved three different steps: (i) use of P800 (3M Imperial Sandpaper) SiC polishing paper, (ii) followed by P1600 (3M Imperial Sandpaper) SiC polishing paper and (iii) finally a 0.1 μm Al₂O₃ powder dispersion. Sonication in DI water and acetone was used to remove organic and inorganic compounds from the SS surface.

### Synthesis of RuO, Thin Films for Use in Example Embodiments

RuOₓ thin films were deposited using sputter deposition from a stoichiometric RuO₂ target (3 inch, 99.995% purity, ALB Materials) in an RF magnetron sputtering system (ANELVA®) at room temperature with an Ar/O₂ plasma. The target was pre-sputtered at 50 W for 10 minutes, which was followed by deposition for five hours at the same power. During the deposition, the sample stage was rotated at 40 rpm to ensure uniform deposition. The background pressure was in the range ˜2×10⁻⁶ Torr. The flow rates of Ar and O₂ were adjusted to vary the composition of Ar and O₂ in the mixed plasma (Table 2). Depositions were carried out at 4.00 mPa.

### Characterization of RuOₓ Thin Films for Use in Example Embodiments

All samples were weighed before and after sputter deposition using a RADWAG-MYA/2Y microbalance (resolution: 0.001 mg) to determine the mass of the deposited RuOₓ. Surface morphologies and cross-sections were observed using a field-emission scanning electron microscope (FE-SEM, FEI Inspect F50) equipped with an Energy Dispersive X-ray spectrometer (EDX, Oxford PentaFET) used for chemical analysis (performed at 10 KeV).

The crystal structure of the sample was characterized using X-ray diffraction (XRD, Bruker D8 Advance) with Cu Kα₁ radiation at a scan rate of 1° min⁻¹ for 2Ø between 20 and 90 (both powder diffraction and single crystal XRD were carried out), as well as high-resolution selected area electron diffraction (SAED) using a JEOL 2100F transmission electron microscope (TEM) operating at 200 keV. Cross-sectional samples were prepared for TEM characterization by depositing 50 nm of carbon and 150 nm of platinum followed by ion milling using a focus ion beam in a system also equipped for scanning electron microscopy (FEI Nova 600i Nanolab).

### Electrochemical Measurements of RuOₓ Thin Films for Use in Example Embodiments

Electrochemical tests were conducted in a half-cell setup using a tom cell. Half-cells consisting of as-prepared RuOₓ cathodes, lithium metal anodes and lithium reference electrodes were characterized using a 1 M LiPF₆ in ethylene carbonate/diethyl carbonate (V/V=1:1) electrolyte, and a Celgard poly-propylene separator. Cells were assembled in an Ar-filled glove box with H₂O and O₂ levels less than 0.1 ppm. Investigations of the electrochemical performance were performed outside the glove box at room temperature. Cyclic Voltammetry (CV) and galvanostatic cycling were carried out from 0.75 to 3.6 V with respect to the Li/Li⁺ electrode using a BioLogic VMP3 station and NEWARE High Precision Battery Testing System. The charge and discharge cycles refer to the lithiation and delithiation of the RuOₓ electrode, respectively. Charge/discharge cycles were performed at a current density of 30 μA/cm² (corresponding to ˜75 mA/g, ˜0.1 C).

### Results and Discussion of RuOₓ Thin Films for Use in Example Embodiments

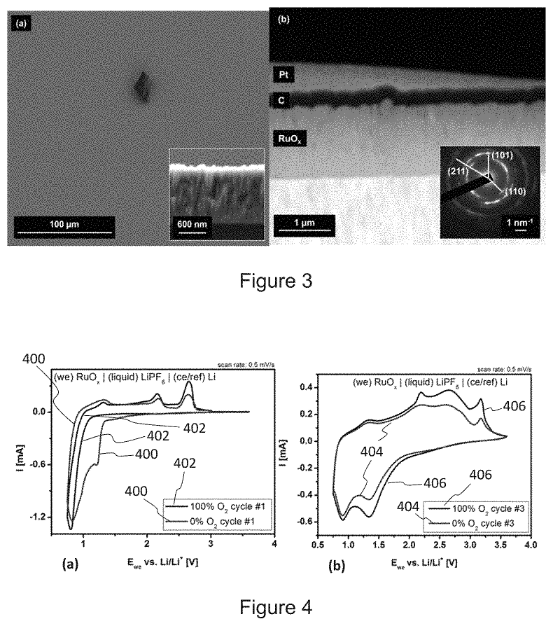

FIG. 3(a) shows FE-SEM top-view and cross-section (insert) images of an as-deposited RuOₓ thin film. A columnar structure was detected in the cross-sectional image while the top surface was found to be relatively smooth. The surface morphology of the thin film was not affected by the Ar/O₂ plasma composition. TEM analysis of an RuOₓ thin film deposited using a pure O₂ plasma showed a columnar structure (FIG. 3(b)) and selected area diffraction patterns (SAEDP), FIG. 3 (b-insert), showed that the as-deposited RuOₓ thin film had a polycrystalline nanostructure.

Cross-sectional SEM images were used to evaluate thin film thickness, which, in turn, was used to evaluate the specific volumetric capacity. Thickness measurements also allow determination of an average growth rate under different plasma conditions (Table 2). As the O₂ mole fraction in the plasma was increased, the total mass and thickness of the deposited material decreased. The calculated mass density and growth rate decreased accordingly, from 9.18 to 6.17 g/cm³ and from 2.6 to 1.2 nm/min, respectively. The density of the as-deposited RuO_{1.92} is slightly lower than the theoretical density of crystalline RuO₂ (6.97 g/cm³). The differences in the film density shown in Table 2 can be attributed to an increase in the weight percentage of oxygen within the RuOₓ films with increasing oxygen partial pressure in the O₂/Ar plasma. This has also been confirmed using EDX and Rutherford backscattering spectrometry (RBS) measurements, which indicated the weight percentage of the different elements in the films (Table 2): the ruthenium-to-oxygen ratio of the films increased with the mole fraction of O₂ in the sputtering gas. A 26.4% oxygen plasma (which corresponds to a pO₂ of about 1.056 mPa) leads to an oxygen content close to the ruthenium oxide stoichiometric value (RuO_{1.92}).

TABLE 2
Physical characteristics and EDX analysis of as-deposited RuOₓ thin films.

| O₂ in | | Deposited | Calculated | Calculated | | | |
|---|---|---|---|---|---|---|---|
| plasma | Thickness | mass | density | growth rate | Ruthenium | Oxygen | Oxygen |
| [%] | [nm] | [mg] | [g/cm³] | [nm/min] | [%] | [%] | stoichiometry |
| 0 | 769 ± 11 | 0.798 ± 0.002 | 9.18 | 2.56 | 83.7 | 16.3 ± 1.4 | 1.23 |
| 18.2 | 659 ± 6 | 0.582 ± 0.001 | 7.81 | 2.20 | 79.2 | 20.8 ± 0.8 | 1.66 |
| 26.4 | 593 ± 5 | 0.449 ± 0.011 | 6.70 | 1.98 | 76.7 | 23.3 ± 2.2 | 1.92 |
| 50.0 | 468 ± 5 | 0.370 ± 0.003 | 6.99 | 1.56 | 72.5 | 27.5 ± 1.5 | 2.39 |
| 100 | 360 ± 6 | 0.251 ± 0.003 | 6.17 | 1.20 | 72.0 | 28.0 ± 3.6 | 2.46 |

FIG. 4(a) shows cyclic voltammetry results for the first charge-discharge cycle in the voltage range 0.75-3.6 V for RuOₓ films deposited using pure Ar and pure O₂ plasmas. During the first lithiation, for RuOₓ grown in Ar (curve 400), three peaks are observed at 0.90, 1.21 and 1.51 V, indicating a multi-step lithiation process. As reported elsewhere [29-31], the experimental observations are consistent with a two-step mechanism for lithium insertion, the first of which is a simple intercalation of lithium ions in the RuO₂ crystal lattice, forming a orthorhombic LiRuO₂ structure, followed by conversion at higher capacities into nanocrystalline Li₂O and Ru nano-/amorphous phases [30]. In contrast, RuOₓ films deposited with pure oxygen (curve 402) show a single CV peak at 0.80 V (FIG. 4(a)). In the first delithiation, RuOₓ films deposited using pure Ar showed three peaks at 1.30, 2.16 and 2.65 V, which are similar to the values observed during the first delithiation of RuOₓ films deposited using a pure O₂ plasma (1.30, 2.15 and 2.66 V). From the second CV cycle onwards, both Ar plasma (curve 404) and O₂ plasma (curve 406) samples exhibit two lithiation peaks (1.15 and 0.90 V) and four delithiation peaks (1.33, 2.16, 2.68 and 3.17 V), see FIG. 4(b). That these voltages are similar in both sets of samples after the first lithiation, suggests that the lithiation/delithiation mechanisms are the same after the first cycle.

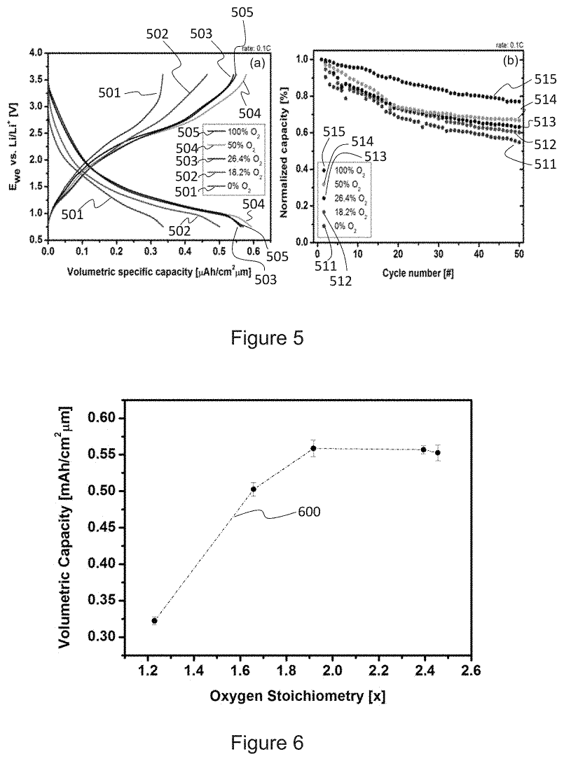

FIG. 5 shows the cycling behavior of RuOₓ films deposited with different Ar/O₂ ratios. First-cycle charge/discharge profiles (FIG. 5(a)) show regions of reduced slope at similar potentials across all samples, curves 501-505 (1.75 and 0.9 V during discharge and 1.3, 2.1, 2.7 V during charge). Increasing the oxygen partial pressure during deposition led to films with higher oxygen contents and to enhanced capacities, showing a higher volumetric capacity (0.55 mAh/cm²μm) for 100% O₂ than films deposited using a pure Argon plasma (0.32 mAh/cm²μm). The capacity increase can be attributed to the increased availability of oxygen for formation of Li₂O during lithiation of the electrode [29-31. In addition, the cycling stability was increased significantly when 0₂ was introduced in the sputtering gas, see curves 511 to 515 in FIG. 5(b). After 50 cycles at 0.1 C, the RuOₓ film deposited using a pure O₂ plasma can still deliver a capacity of 425.6 μAh/cm²μm, indicating a capacity retention of 77.01%, compared to 176.55 μAh/cm²μm with a retention of 54.76% for films deposited using a pure Ar plasma. During the delithiation phase of charge/discharge cycles, high tensile stresses develop within the RuOₓ thin films, due to repeated volume expansion/contraction. As previously reported by Zhu et al. [32-33], this can lead to crack formation and propagation of microcracks, resulting in a subsequent pulverization and delamination of the film from the current collector.

RuOₓ films can provide an overall volumetric energy of about 1014.2 mWh/cm²μm, which is 5 times greater than that of LiCoO₂ films volumetric specific energy (˜248.5 mWh/cm²μm). Considering only active material, our results for both specific capacity and energy density are in good agreement with previous results given by Kim et al. [29] for RuO₂ powders. That the high capacity of RuOₓ electrodes can be obtained in as-deposited thin films demonstrates their great potential for use in high performance TFMs

While RuOₓ films can exhibit a relatively large voltage variation as a function of the state of charge (i.e. the absence of a voltage plateaus), compared to materials such as LiCoO₂ and LiFePO₄, for TFMs, this limitation can be overcome by developing an integrated control circuit. Electronic circuits typically require a stable (constant voltage) and clean (low noise) power supply voltage as many parameters that define their performance depend on the supply voltage. In general, any battery is only partially able to supply a sufficiently stable clean voltage because its output voltage reduces and its output impedance increases as the energy capacity diminishes, and its output voltage dips when a large current is drawn. To circumvent these limitations, a power management circuit is routinely employed embodying a DC-DC converter [34-37] to provide a stable supply voltage from a poorly defined output battery voltage—a Boost DC-DC converter [37] to step-up (increase) the output voltage or Buck DC-DC [34] to step-down (reduce) the output voltage. If a very stable or low-noise output voltage is required, a Low-DropOut (LDO) voltage regulator is applied to the output of the DC-DC converter. In general both the DC-DC converter and LDO feature low output impedance. In other words, power management can be employed to provide a stable and clean supply voltage despite the high variation in the voltage supplied by a RuOₓ-based thin film microbattery according to example embodiments.

The stoichiometry of the films was found to depend strongly on the O₂ content of the Ar/O₂ sputtering gas. Use of plasmas with low oxygen contents leads to lower oxygen contents in the films. Experimental results also showed that the Ru to O ratio in the thin film has a significant effect on the electrochemical performance, both the volumetric specific capacity (see curve 600 in FIG. 6) and capacity retention. In general, volumetric capacities of RuOₓ films were higher at greater oxygen concentrations. Volumetric capacities increased with x and approached a plateau of 0.55 mAh/cm²μm beyond x=2. This value is very close to the very high theoretical reversible capacity of crystalline RuO₂ (0.56 mAh/cm²μm), making RuOₓ films sputter deposited at room temperature suitable as next generation high-capacity cathode materials in thin film Li-ion microbatteries. Synthesis of high capacity cathode layers using only room temperature processes according to example embodiments makes integration with fabrication of other micro-devices and microsystems, such as integrated circuits, much more feasible, advantageously enabling many novel TFMs applications.

### High Capacity, Improved Cyclability and Safety Anodes According to Example Embodiments

In view of e.g. safety issues when using pure Li metal as the anode and the reduced reliability when using high capacity anode (Si), example embodiments advantageously use Ge based anode material for Li-ion thin film microbatteries. In microbatteries traditional anode materials are pure Li and Si thin film. Although Si is known as the material characterized by the highest gravimetric specific capacity (˜4.4 Li atoms per Si atom, ˜0.83 mAh/cm²μm), it suffers from a very high volume expansion while cycling (˜420%). In the thin film forms, this volume expansion leads to a very high stress evolution resulting in a very low cyclability of the electrode.

The advantages of Ge thin film anodes when used in Li-ion microbatteries according to example embodiments can include: (i) higher reliable areal capacity compared to Si, in spite of Ge having a lower volumetric specific capacity compared to Si; (ii) the rate of charge and discharge for Ge is higher than for Si; (iii) Ge has improved safety compared to pure Li.

While Ge has a higher volumetric specific capacity than conventional anode materials like carbon, it is only about 90% (˜0.74 mAh/cm²μm) that of Si. However, it has been recognized by the inventors that volumetric specific capacity is not the only one key parameter to be taken in account: cycle life is also a very important feature of Li-ion microbatteries. Cycle life is defined by the number of charge/discharge cycles that a battery can lasts before starts to reduce visibly (conventionally 80/85% of the initial capacity) its performance.

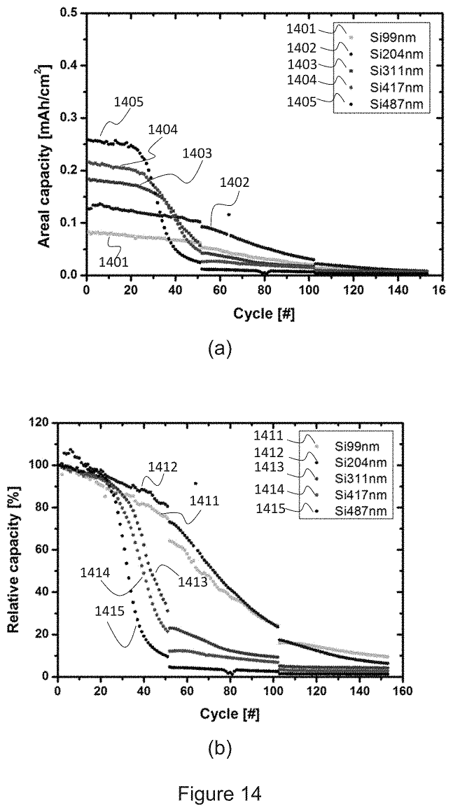

As mentioned above, lithiated Si suffers from a large volume expansion of about 420%, whereas Ge only has a volume expansion of about 270% [10]. It has been recognized by the inventors that this difference in volume expansion causes different reliable areal specific capacities for Si and Ge in the thin film form. From experiments with example embodiments of the present invention, it was found that Ge, curves 200a-c, can cycle well at higher thin film thickness compared to Si, curves 202a-c, as shown in FIG. 2. This translates to Ge advantageously having a reliable areal specific capacity of about 330 μAh/cm² compared to Si's 120 μAh/cm². This three-fold increase in reliable areal specific capacity of Ge over Si, makes it more preferred Li-ion thin film microbattery anode material. Also shown in FIG. 2 is data, curves 204a-c, collected on a 487 nm thick Si film covered by 1 μm thick LiPON film according to an example embodiment. As will be described further below with reference to FIGS. 14 to 17, LiPON film on top of the active material (both Si and Ge), advantageously enhances the life cycle of the underneath material significantly, according to example embodiments.

In the half-cell configuration (i.e. a configuration with a Ti/Pd current collector and Ge/Si thin film, a solid electrolyte (LiPON), a liquid electrolyte (LiPF₆) and a Li foil as a counter electrode), a cycle life of about 42 and 247 cycles for 487 nm Si and 548 nm Ge thickness respectively.

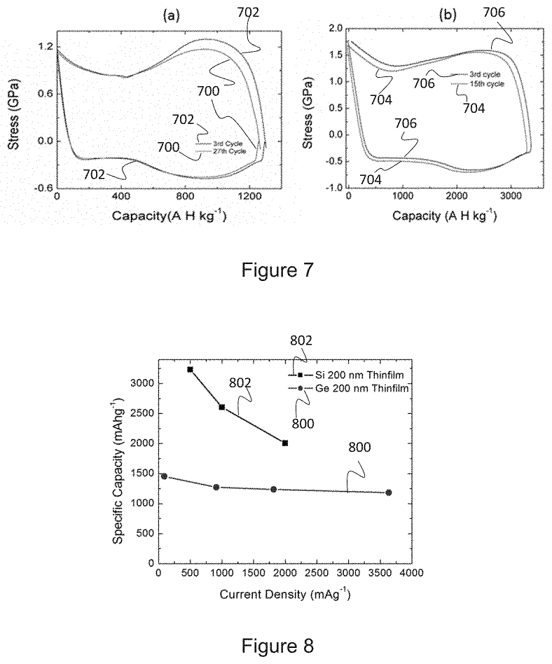

The reason for the difference in cycling performance between Si and Ge is believed to be evident from comparative in-situ stress evolution studies during lithiation/delithiation. It was found that Ge inelastically deforms at much lower stresses than Si. Ge (see curves 700, 702 in FIG. 7(a) for the 27^{th} and 3^{rd} cycle, respectively) has an absolute stress range of 1.5 GPa and Si (see curves 704, 706 in FIG. 7(b) for the 15^{th} and 3^{rd} cycle, respectively) has an absolute stress range of 2.2 GPa, which corresponds to Si having 47% higher absolute stress than Ge as shown in FIGS. 7(a) and (b). Si is therefore more susceptible to fracture and pulverization than Ge during lithiation/delithiation.

It has been reported that the diffusivity of Li-ions in Ge is 400 times higher than in Si at room temperature [12,13]. Here, Li-ions diffusivity is taken to be a measure of the lithiation and delithiation rates. Enhanced diffusivity of Li-ions in Ge compared to Si, is an added advantage to using Ge as a Li-ion anode, according to example embodiments. This advantageously enhances the rate performance of Ge anodes, curve 800, compared to Si anodes, curve 802 (FIG. 8), thereby increasing the rate performance of microbatteries with Ge anodes according to example embodiments.

Pure Li-metal can be used as a high capacity (0.206 mAh/cm²μm) anode material which also serves as Li-ions source in a microbattery. However, safety concerns limit the use of Li-metal as an anode. Potential Li dendrite formation resulting in a short circuit of electrodes, or exposure of Li-metal (in the event of encapsulation failure) to atmospheric ambient resulting in explosive combustion, make it an unsafe anode to be used in commercial Li-ion batteries. Use of Ge anodes in Li-ion microbatteries according to example embodiments advantageously eliminates the need for having Li in its pure metallic phase. Moreover, the theoretical volumetric capacity of Ge anodes (˜0.74 mAh/cm²μm) is higher than that of Li metal, resulting in a volumetric capacity advantage of example embodiments of the present invention as well.

Ge thin-films can be deposited through a variety of techniques such as, but not limited to: chemical vapor deposition [16], electrodeposition [17] and physical vapor deposition [18]. Specifically, Ge anodes can be deposited through sputtering, a physical vapor deposition technique according to an example embodiment. In the following, implementation of Ge thin films in a full microbattery stack according to example embodiments will be described.

The advantages of using a pre-lithiation technique according to example embodiments described herein can include: (i) it makes possible to use Li-free cathode materials; (ii) it leads to improved cyclability/reliability; (iii) it can provide the ability to tailor the amount of Li incorporation to better manage performance vs. cyclability trade-offs; (iv) it can provide improved safety when compared to the use of pure Li-metal; and (v) it can ensure that the Li is never in the form of metallic Li, thereby arresting any stray motion of Li-ions, advantageously making the microbattery stack CMOS compatible when integrated with electronic circuitry.

Li-ion thin film microbatteries can be deposited through a variety of techniques such as, but not limited to: the sol-gel method [19], chemical vapor deposition [20], electrodeposition [21], ALD [22] or physical vapor deposition [8]. Sputtering deposition is a physical vapor deposition technique. Several examples of how sputter deposition can be used to create pre-lithiated thin films according to example embodiments are described herein. Similar strategies would apply for other film formation techniques in different embodiments. Pre-lithiation of anodes (such as Si or Ge) can be achieved by at least three different sputtering process: (i) sputtering of a pre-lithiated target, (ii) bi-layer, (iii) co-sputtering or (iv) multi-layer deposition.

In the sputtering of a pre-lithiated target according to example embodiments, Li is present within the stoichiometric structure of the target material such as LiₓSi_{y}, LiₓGe_{y}. The fabrication process of the target material may involve chemical methods, electrochemical methods, solid-state reactions, sol-gel preparations. Optimal Li-loading of the electrode can be achieved by engineering the stoichiometry of the target material.

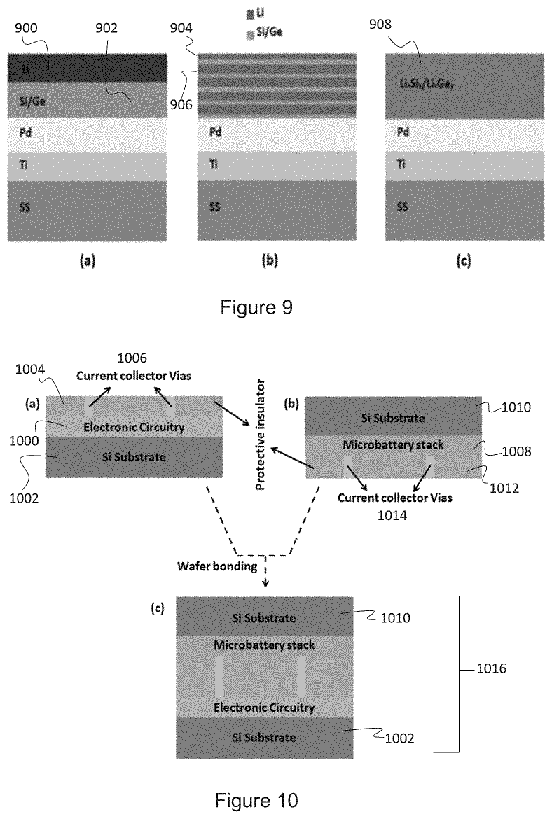

In the Bi-layer process (FIG. 9(a)) according to one embodiment, Li layer 900 is deposited separately on top of the electrode active material layer 902. Lithiated electrodes according to such embodiments are formed through solid-state chemical reactions due to the high chemical reactivity of Li with the electrode active materials. Optimal Li-loading of the electrodes can be achieved by engineering the electrode thin layer 902 to lithium layer 900 thickness ratio. The substrate temperature and other parameters during deposition can be used to control the reaction between the electrode active material layer 902 and Li layer 900.

In the Multi-layer process (FIG. 9(b)) according to another embodiment, alternating thinner layers (compared to the bi-layer process, FIG. 9(a)) of Li 904 and electrode active material 906 are deposited. When the chemical interaction between Li 904 and the electrode active material 906 is lower, this technique preferably ensures a uniform pre-lithiation. The thickness of each individual layer depends on the ease of chemical interaction between Li 904 and the active material 906. The substrate temperature and other parameters during the deposition can be used to control the reaction between the electrode active material layers 906 and Li layers 904.

In the Co-sputtering process (FIG. 9(c)), Li is sputtered together with the electrode active material in the same sputtering chamber at the same time. This can ensure a uniform mix of Li and the active material through the thickness of the deposited film 908. Optimal Li-loading of the anode can be achieved by engineering the active material to lithium deposition-rate ratio.

In the three processes described above with reference to FIGS. 9(a)-(c), an additional post-deposition annealing can be used to enhance the chemical reaction between Li and the electrode active material, thereby resulting in a highly uniform pre-lithiated electrode.

All the four different sputtering processes described above have been investigated according to example embodiments. Presently, the best results have been achieved following the bi-layer process. However, it is believed that by e.g. using an adequate sputtering tools, which allows several depositions without breaking the vacuum (i.e. without exposing target materials and samples to atmosphere), all the four different sputtering processes described above can result in a complete pre-lithiation electrode synthesis.

### Design and Process Fabrication for Integrable Li-Ion Thin Film Microbatteries and/or Arrays According to Example Embodiments

High areal/volumetric specific capacity and microbattery cyclability according to example embodiments can enable complex integrated circuits (ICs) with tight (i.e. CMOS-level) integration between the electronic circuits and the microbatteries. The microbatteries can preferably have the required energy capacity to power the selected parts of the ICs, and preferably have sufficient reliability to last for the useful life of the ICs. This can advantageously lead to an overall miniaturization of the size of ICs, due to the optimal use of the available areal footprint.

Additionally, integrable microbattery arrays, when paired with CMOS power management circuits according to example embodiments, can allow for customizable and controllable power output, which would allow the optimal use of a microbattery's stored charge, regardless of its output voltage as a function of its charge state (which would address potential challenges faced by microbatteries with large output voltage variation such as the RuO₂ cathode microbatteries described earlier). Smart integrated power management circuits can also be expected to enhance the reliability of the microbatteries (and therefore the entire IC) due to their ability to properly regulate charging and discharging operations for maximal circuit life and efficiency.

Integration of Li-ion thin film microbatteries makes a Li-ions barrier layer and the use of a CMOS compatible processes desirable to fabricate the microbattery.

A critical issue in integrated microbatteries is the possibility of contamination of the electronic circuitry by Li-ions. This can affect the electronic circuitry's operation. To prevent Li-ions diffusion and other possible contamination, the right choice of protective insulators is important. A Li-ion barrier layer of Si₃N₄ (also referred as SiN) and/or SiO₂ thin films are used in example embodiments which can be deposited by several methods such as, but not limited to, chemical vapor deposition, ALD, physical vapor deposition or thermal oxidation. By using a Li-barrier layer it is preferably possible to stop any stray motion of Li-ions, making the microbattery stack CMOS compatible. A protective/passivation/encapsulation layer of the microbattery is also desirable to protect the microbattery from the exposure to atmosphere. A Parylene C thin film as passivation layer deposited by a room-temperature CVD process is used according to an example embodiment, advantageously improving the overall compatibility with CMOS processes.

CMOS compatible processes to fabricate the microbattery can be classified in two different families: (i) separate fabrication of electronic circuitry and microbatteries on silicon substrates, followed by wafer-bonding; or (ii) direct deposition of the microbattery on the top/bottom of the fabricated electronic circuitry. The techniques and advantages of both these routes according to example embodiments are discussed below.

Wafer-bonding is an established technology for SOI wafers [23], MEMS [24] and strained-Si [25] fabrication. This technique can also be used to integrate microbatteries with electronic circuitry. In this case, the electronic circuitry 1000 (i.e. one or more electronic circuitry layers) is first fabricated on a Si substrate 1002 with appropriate protective insulation layers 1004 and vias 1006 for current conduction (FIG. 10(a)). The microbattery stack 1008 is separately fabricated on a Si substrate 1010, also with appropriate protective insulation layer 1012 and vias 1014 for current conduction (FIG. 10(b)). These two wafers/substrates 1002, 1010 are then wafer-bonded as shown as an example embodiment of an integrated microbattery 1016 in FIG. 10(c). The choice of wafer-bonding technique can include [24], but is not limited to: direct bonding, anodic bonding or intermediate layer-bonding. The advantage of the wafer-bonding technique includes that there is no limitation on high temperature annealing processes in the fabrication of the microbattery stack 1008. Electronic circuitry is susceptible to failure and performance degradation when high temperature annealing is conducted post-integration. Microbatteries typically consist of three important thin-film layers: anode, cathode and electrolyte. The performance of individual thin-films might be improved through high-temperature annealing. For instance, LiCoO₂ is used as a popular thin-film cathode and to achieve high specific capacity the film has to be annealed at 700° C. [26]. Potential thin-film electrolytes such as LAGP also require annealing at 650-800° C. [27] for improved ionic conductivity.

Microbattery integration through wafer-bonding is believed to be preferred when high temperature annealing processes are essential to the fabrication of the microbattery stack.

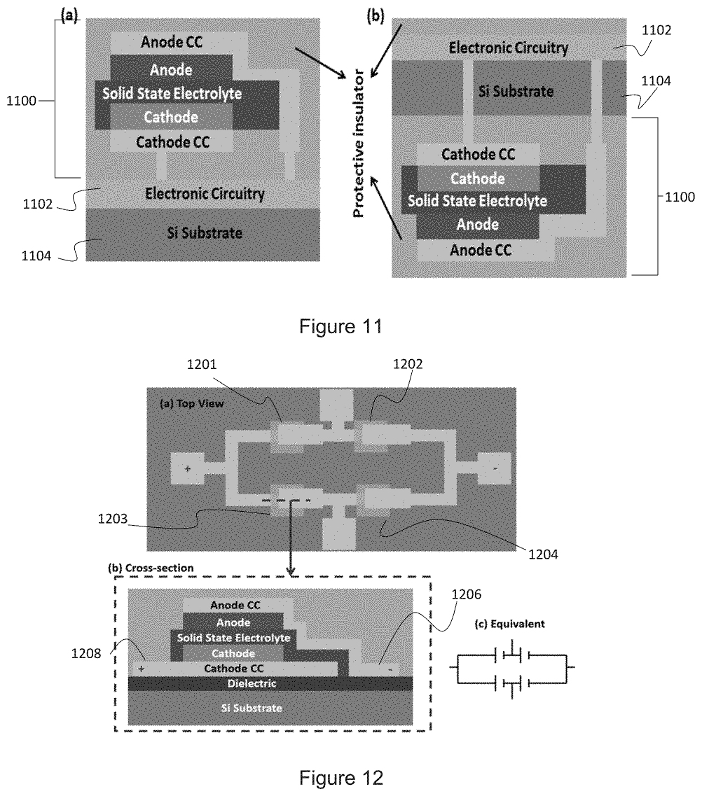

When no annealing is required for the microbattery stack fabrication, the stack can be directly deposited on the electronic circuitry's (i.e. one or more electronic circuitry layers) substrate. One specific example in this case is RuO₂, a Li-ion cathode material. RuO₂ does not require annealing as it interacts with Li-ions chemically to form a new phase, rather than through intercalation (LiCoO₂) mechanism which requires that the material be crystalline and therefore generally requires high temperature annealing. An example of a microbattery stack fabricated completely at room temperature is composed by RuO₂ (cathode), LiPON (electrolyte) and pre-lithiated LiₓSi_{y} (anode) [28]. In this approach, there is no need for wafer-bonding as the entire fabrication takes place on a single Si substrate. The microbattery stack 1100 can be deposited on top of the electronic circuitry 1102 (FIG. 11(a)) or alternatively can be deposited on the back side of the Si substrate 1104 (FIG. 11(b)). The latter option (FIG. 11(b)) has the added advantage of the microbattery stack being separated from the electronic circuitry due to thick Si substrate in between, limiting interactions due to Li transport/migration out of the microbattery.

In both integration processes, the thin-films of the microbattery can be deposited through a variety of techniques such as, but not limited to: the sol-gel method [19], chemical vapor deposition [20], electrodeposition [21], atomic layer deposition [22] or physical vapor deposition [8]. Sputtering is a physical vapor deposition technique and unlike chemical vapor deposition does not require complex precursor and ambient chemistries. Also, to deposit patterned microbattery thin-films such as those shown in FIG. 10 and FIG. 11, shadow masks can be used in conjunction with sputter deposition.

Integrable microbatteries can be fabricated to include more than one individual battery cell. FIG. 12(a) shows a schematic top-view of an example of a microbatteries array with 4 individual cells 1201-1204 (FIG. 12(c) shows the equivalent circuit). The array can be designed to suit power requirements. It is desirable to ensure that both the anode and cathode current collectors 1206, 1208, respectively, are at the same level as shown in FIG. 12(b).

Microbattery arrays can have the following advantages: (i) customizable power output, and (ii) improved reliability.

The amount of current and voltage drawn from the microbattery array can be customized. Using the same active battery materials, different current and voltage performance can be achieved. In the equivalent circuit shown in FIG. 12(c), the current and voltage drawn from the array is twice as much as that drawn form an individual cell. Therefore, arrays can power a variety of application using the same active battery materials. When integrated with power management circuitry, the battery array can also be reconfigured on-the-fly to modify voltage and power.

Additionally, arrays are more reliable compared to individual cells. A single cell might fail due to material failure during operation. As an example, consider when two cells are connected in parallel. Even when one of the cells fails, the same voltage can be drawn albeit at half of the current. To further improve reliability, the battery array can be designed in such a way that the non-functioning cells can be by-passed.

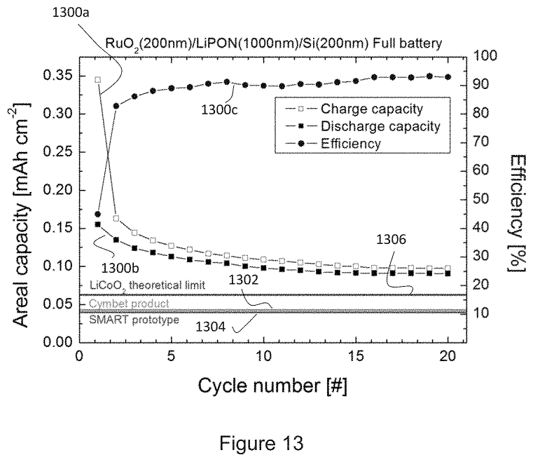

FIG. 13 shows a plot showing electrochemical performance of a proof-of-concept CMOS-integrable microbattery prototype example embodiment based on RuO₂ cathode, LiPON electrolyte, pre-lithiated Si anode. In particular a comparison between the example embodiment and state-of-the-art is reported (Cymbet®). Furthermore, a comparison with theoretical limit of Li-containing transition metal oxide (LiCoO₂) is reported (“state-of-the-art Li-ion thin film microbattery cathode is typically restricted to LiMₓO_{y} stoichiometries where M is a transition metal such as Co, Mn, Ni or a mixture of transition metals”). In particular, curves 1300a-c show the charge capacity, the discharge capacity and the efficiency, respectively, for RuO2|LiPON|pre-lithiated Si, according to an example embodiment. Line 1302 illustrates the theoretic limit of the state of the art based on LiCoO2|LiPON|Li, line 1304 illustrates previous results based on LiCoO2|LiPON|Si, and line 1306 illustrates the highest performance theoretically achievable using LiCoO2 cathode.

FIG. 14a) shows a graph illustrating Si areal capacity as a function of charge/discharge cycle at different rate (C/4; C/2 and C) for different Si thicknesses (curves 1401-1405). FIG. 14b) shows a graph illustrating Si relative areal capacity normalized to first charge/discharge cycle at different rate (C/4; C/2 and C) for different Si thicknesses (curves 1411-1415). Table 3 shows forecasts on cycle life of Si anodes at different thicknesses.

TABLE 3

| | | | |
|---|---|---|---|
| 99 | nm | 177 | cycles |
| 204 | nm | 173 | cycles |
| 311 | nm | 69 | cycles |
| 417 | nm | 57 | cycles |
| 487 | nm | 42 | cycles |

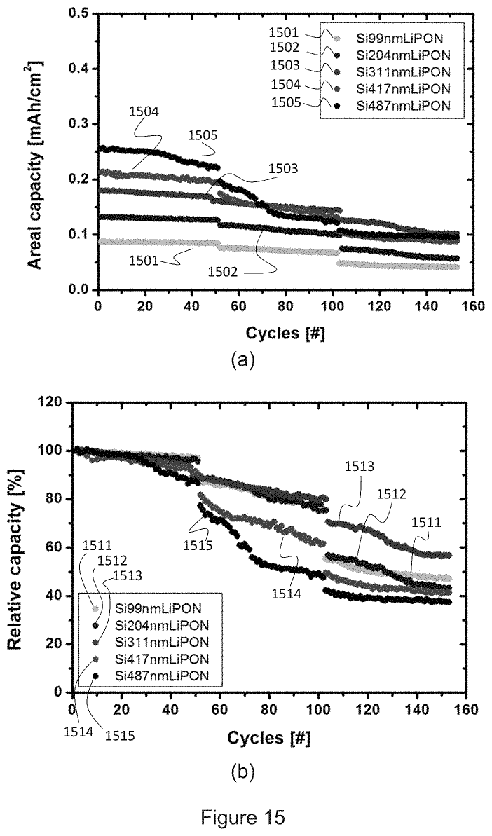

FIG. 15a) shows a graph illustrating Si/LiPON areal capacity as a function of charge/discharge cycle at different rate (C/4; C/2 and C) for different Si thicknesses (curves 1501-1505). FIG. 15b) shows a graph illustrating Si/LiPON relative areal capacity normalized to first charge/discharge cycle at different rate (C/4; C/2 and C) for different Si thicknesses (curves 1511-1515). Table 4 shows forecasts on cycle life of Si/LiPON anodes at different thickness.

TABLE 4

| | | | |
|---|---|---|---|
| 99 | nm | 303 | cycles |
| 204 | nm | 298 | cycles |
| 311 | nm | 226 | cycles |
| 417 | nm | 83 | cycles |
| 487 | nm | 56 | cycles |

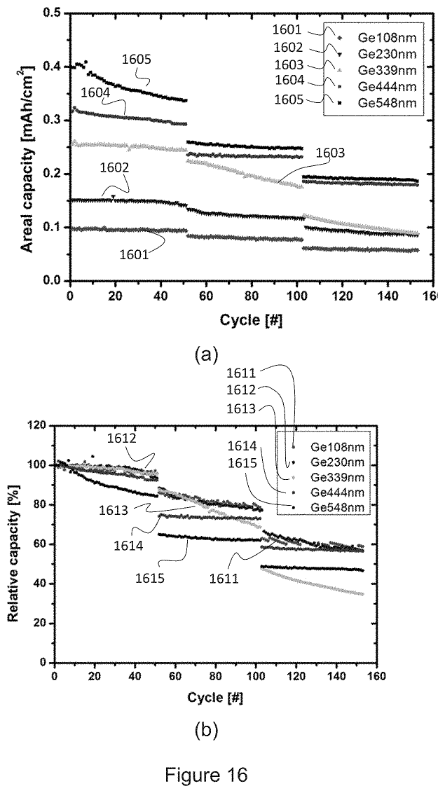

FIG. 16a) shows graph illustrating Ge areal capacity as a function of charge/discharge cycle at different rate (C/4; C/2 and C) for different Ge thicknesses (curves 1601-1605). FIG. 16b) shows a graph illustrating Ge relative areal capacity normalized to first charge/discharge cycle at different rate (C/4; C/2 and C) for different Ge thicknesses (curves 1611-1615). Table 5 shows forecasts on cycle life of Ge anodes at different thickness.

TABLE 5

| | | |
|---|---|---|
| 108 nm | 1158 | cycles |
| 230 nm | 821 | cycles |
| 339 nm | 928 | cycles |
| 444 nm | 553 | cycles |
| 548 nm | 247 | cycles |

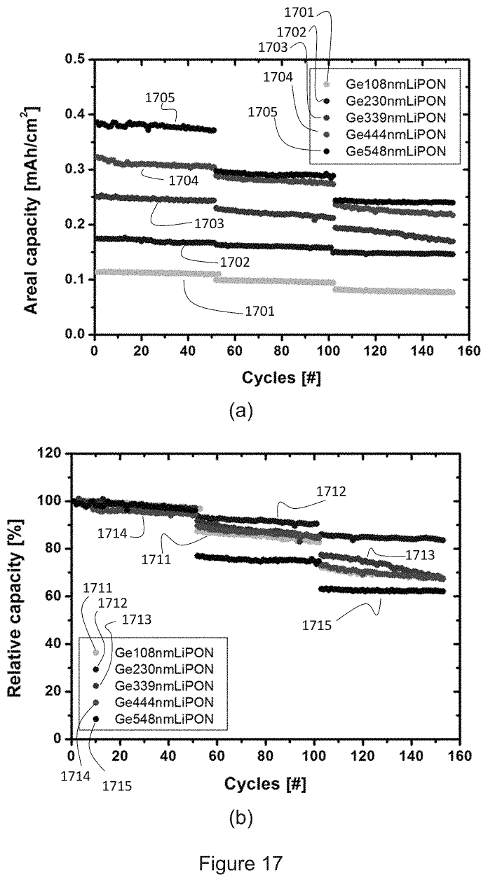

FIG. 17a) shows a graph illustrating Ge/LiPON areal capacity as a function of charge/discharge cycle at different rate (C/4; C/2 and C) for different Ge thicknesses (curves 1701-1705). FIG. 17b) shows a graph illustrating Ge/LiPON relative areal capacity normalized to first charge/discharge cycle at different rate (C/4; C/2 and C) for different Si thicknesses (curves 1711-1715). Table 6 shows forecasts on cycle life of Ge/LiPON anodes at different thickness.

TABLE 6

| | |
|---|---|
| 108 nm | 1471 cycles |
| 230 nm | 1503 cycles |
| 339 nm | 1488 cycles |
| 444 nm | 1275 cycles |
| 548 nm | 1186 cycles |

As can be seen from FIGS. 14 to 17, advantageously (i) —LiPON coating stabilizes mechanically the underneath layers, preventing the solid-electrolyte interface (SEI) formation and enhancing the life cycles of the films, according to example embodiments, and (ii) Ge behaves better than Si, according to different embodiments.

According to one embodiments, a Li-ion thin film microbattery is provided comprising a Li-free cathode comprising a transition metal oxide thin film; an anode comprising a lithiated Ge or Si thin film; and an electrolyte film disposed between the cathode and the anode; wherein a Li-source of the Li-ion thin film microbattery is provided by means of the lithiated Ge or Si thin film.

The transition metal oxide may comprise V₂O₅, CrO₃, and/or RuO₂. The electrolyte film may comprise LiPON. The Li-ion thin film microbattery may further comprise one or more power management electronic circuitry layers electrically coupled to the cathode and the anode. The management electronic circuitry layers may be formed on a first substrate and a microbattery stack comprising the Li-free cathode, the anode, and the electrolyte film are formed on a second substrate, and wherein the first and second substrates are bonded to each other on respective tops surfaces thereof. The power management electronic circuitry layers and a microbattery stack comprising the Li-free cathode, the anode, and the electrolyte film may be formed on the same substrate. The electronic circuitry layers and the microbattery stack may be formed on the same side of the substrate. The electronic circuitry layers and the microbattery stack are formed on opposite sides of the substrate. The Li-ion thin film microbattery may comprise current collection contacts for the Li-free cathode and the anode, respectively, arranged at the same level.

In one embodiment, a microbattery array comprising two or more of the Li-ion thin film microbattery of the above described embodiment is provided.

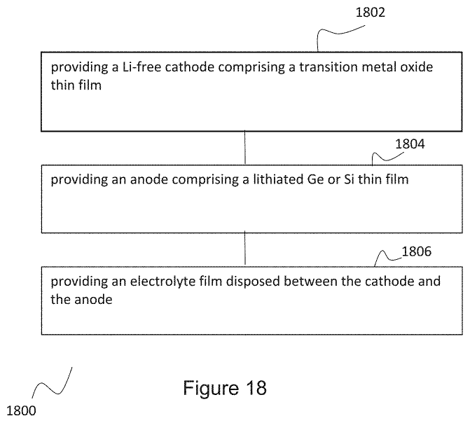

FIG. 18 shows a flow chart 1800 illustrating a method of fabricating a Li-ion thin film microbattery, according to an example embodiment. At step 1802, a Li-free cathode comprising a transition metal oxide thin film is provided. At step 1804, an anode comprising a lithiated Ge or Si thin film is provided. At step 1806, an electrolyte film is disposed between the cathode and the anode, wherein a Li-source of the Li-ion thin film microbattery is provided by means of the lithiated Ge or Si thin film.

The transition metal oxide may comprise V₂O₅, CrO₃, and/or RuO₂. The electrolyte film may comprise LiPON. The method may further comprise providing one or more power management electronic circuitry layers electrically coupled to the cathode and the anode. The power management electronic circuitry layers may be formed on a first substrate and a microbattery stack comprising the Li-free cathode, the anode, and the electrolyte film are formed on a second substrate, and wherein the first and second substrates are bonded to each other on respective tops surfaces thereof. The method may comprise forming the power management electronic circuitry layers and a microbattery stack comprising the Li-free cathode, the anode, and the electrolyte film on the same substrate. The method may comprise forming the electronic circuitry layers and the microbattery stack on the same side of the substrate. The method may comprise forming the electronic circuitry layers and the microbattery stack on opposite sides of the substrate. The method may comprise arranging current collection contacts for the Li-free cathode and the anode, respectively, at the same level. Providing the anode may comprise a bi-layer deposition of the semiconductor material and Li, respectively, and controlling a reaction between the semiconductor material and the Li for the lithiation. Providing the anode may comprise a multi-layer deposition of multiple layers of the semiconductor material and Li, respectively, and controlling a reaction between the semiconductor material and the Li for the lithiation. Providing the anode may comprise a co-deposition of the semiconductor material and Li for the lithiation.

In one embodiment, a method of fabricating a microbattery array is provided, comprising fabricating two or more Li-ion thin film microbatteries using the method of fabricating a Li-ion thin film microbattery of the above embodiment.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. Also, the invention includes any combination of features, in particular any combination of features in the patent claims, even if the feature or combination of features is not explicitly specified in the patent claims or the present embodiments.

### REFERENCES

[1] J. M. Kahn, R. H. Katz and K. S. J. Pister, Proceedings of the 5th Annual ACM/IEEE International Conference on Mobile Computing and Networking (1999), p. 271.
[2] F. Vullum and D. Teeters, J. Power Sources, 146, 804 (2005).
[3] N. J. Dudney, Electrochem. Soc. Interface, 17, 44 (2008).
[4] K. S. Park, Y. J. Park, M. K. Kim, J. T. Son, H. G. Kim and S. J. Kim, J. Power Sources, 103, 67 (2001).
[5] X. He, IDTechEx (2015).
[6] W. C. West, J. F. Withacre, V. White and B. V. Ratnakumar, J. Micromech. Microeng., 12, 58 (2002).
[7] J. B. Bates, N. J. Dudney, B. Neudecker, A. Ueda and C. D. Evans, Solid State Ionics, 135, 33 (2000).
[8] N. J. Dudney, Mat. Sci. Eng. B, 106, 245 (2005).
[9] C. M. Haynes, X. Zhao and H. H. Kung, Annual Review of Chemical and Biomolecular Engineering, 3, 445 (2012).
[10] B. A. Boukamp, G. C. Lesh and R. A. Huggins, J. Electrochem. Soc., 128, 725 (1981).
[11] A. Al-Obeidi, D. Kramer, C. V. Thompson and R. Monig, J. Power Sources, 297, 472 (2015).
[12] X. L. Wu, Y. G. Guo and L. J. Wan, Chem. Asian J., 8, 1948 (2013).
[13] J. Graetz, C. C. Ahn, R. Yazami and B. Fulda, J. Elec. Soc., 151, A698 (2004).
[14] R. S. Omampuliyur, M. Bhuiyan, Z. Han, Z. Jing, L. Li, E. A. Fitzgerald, C. V. Thompson and W. K. Choi, J. Nanoscience and Nanotechnology, 15, 4926 (2015).
[15] B. Lafarge, L. L. Jodin, R. Salot and A. Billard, J. Elec. Soc., 155, A181 (2008).
[16] J. Murota, M. Kato, R. Kricher and S. Ono, Journal de Physique IV, 2, C2-795 (1991).
[17] Q. Huang, S. W. Bedell, K. L. Sanger, M. Copel, H. Delizianti and L. T. Romankiw, Electrochem. Solid-State Lett., 10, D124 (2007).
[18] E. Krikorian and R. J. Sneed, J. Applied Physics, 37, 3665 (1996).
[19] Y. J. Park, J. G. Kim, M. K. Kim, H. Y. Chung, W. S. Um, M. H. Kim and H. G. Kim, J. Power Sources, 16, 41 (1998).
[20] A. Mantoux, H. Groulx, E. Balnois, P. Doppelt and L. Gueroudji, J. Electrochem. Soc., 151, A368 (2004).
[21] E. Poitron, A. Le Gal La Salle, A. Verbaere, Y. Piffard and D. Guyomard, Electrochemica Acta, 45, 197 (1999).
[22] R. B. Hadjean, V. Golabkan, J. P. Pereira-Ramos, A. Mantoux and D. Lincot, J. Raman. Spec., 33, 631 (2002).
[23] K. Mitani and U. M. Gosele, J. Electronic Mat., 21, 669 (1992(.
[24] M. A. Schmidt, Proc. of the IEEE, 86, 1575 (1998).
[25] G. Taraschi, A. J. Pitera and E. A. Fitzgerald, Solid-state Electronics, 48, 1297 (2014).
[26] J. B. Bates, N. J. Dudney, B. J. Neudecker, F. X. Hart, H. P. Jun and S. A. Hackney, J. Elec. Soc., 147, 59 (2000).
[27] D. Safaname, D. Damiano, R. P. Rao and S. Adams, Solid State Ionics, 262, 211 (2014).
[28] N. Liu, L. Hu, M. T. McDowell, A. Jackson and Y. Cui, ACS Nano, 5, 6487 (2011).
[29] Y. Kim, S. Muhammad, H. Kim, Y. H. Cho, H. Kim, J. M. Kim, W. S. Yoon, Chem. Sus. Chem. 8 (2015) 2378-2384.
[30] P. Balaya, H. Li, L. Kienle, J. Maier, Adv. Func. Mat. 13 (2003) 621-625.
[31] A. S. Hassan, K. Moyer, B. R. Ramachandran, C. D. Wick, J. Phys. Chem. C 120 (2016) 2036-2046.
[32] J. Zhu, K. B. Yeap, K. Zeng, L. Li, Thin Solid Films 519 (2011) 1914-1922.
[33] J. Zhu, K. Zeng, L. Li, Metallurgical and Materials Transaction A 44A (2013) S26-S34.
[34] C. Shi, B. Walker, E. Zeisel, B. Hu, G. McAllister, IEEE J. Solid-State Circuits 42 (2007) 1723-1731.
[35] Y. Nakase, S. Kirose, H. Onoda, Y. Ido, Y. Shimizu, T. Oishi, T. Kumamoto, T. Shimizu, IEEE J. Solid-State Circuits 48 (2013) 1933-1942.
[36] D. El-Damak, A. Chandrakasan, IEEE J. Solid-State Circuits 51 (2016) 943-954.
[37] S. Ahsnuzzaman, A. Prodic, D. Johns, IEEE J. Solid-State Circuits 31 (2016) 4305-4323.

1. A Li-ion thin film microbattery comprising:
a Li-free cathode comprising a transition metal oxide thin film;
an anode comprising a lithiated Ge or Si thin film; and
an electrolyte film disposed between the cathode and the anode;
wherein a Li-source of the Li-ion thin film microbattery is provided by means of the lithiated Ge or Si thin film.

2. The Li-ion thin film microbattery of claim 1, wherein the transition metal oxide comprises V₂O₅, CrO₃, and/or RuO₂.

3. The Li-ion thin film microbattery of claim 1, wherein the electrolyte film comprises LiPON.

4. The Li-ion thin film microbattery of claim 1, further comprising one or more power management electronic circuitry layers electrically coupled to the cathode and the anode.

5. The Li-ion thin film microbattery of claim 4, wherein the power management electronic circuitry layers are formed on a first substrate and a microbattery stack comprising the Li-free cathode, the anode, and the electrolyte film are formed on a second substrate, and wherein the first and second substrates are bonded to each other on respective top surfaces thereof.

6. The Li-ion thin film microbattery of claim 4, wherein the power management electronic circuitry layers and a microbattery stack comprising the Li-free cathode, the anode, and the electrolyte film are formed on the same substrate.

7. The Li-ion thin film microbattery of claim 6, wherein the electronic circuitry layers and the microbattery stack are formed on the same side of the substrate or on opposite sides of the substrate.

8. (canceled)

9. The Li-ion thin film microbattery of claim 1, comprising current collection contacts for the Li-free cathode and the anode, respectively, arranged at the same level.

10. A microbattery array comprising two or more of the Li-ion thin film microbattery of claim 1.

11. A method of fabricating a Li-ion thin film microbattery, comprising the steps of:
providing a Li-free cathode comprising a transition metal oxide thin film;
providing an anode comprising a lithiated Ge or Si thin film; and
providing an electrolyte film disposed between the cathode and the anode;
wherein a Li-source of the Li-ion thin film microbattery is provided by means of the lithiated Ge or Si thin film.

12. The method of claim 11, wherein the transition metal oxide comprises V₂O₅, CrO₃, and/or RuO₂.

13. The method of claim 11, wherein the electrolyte film comprises LiPON.

14. The method of claim 11, further comprising providing one or more power management electronic circuitry layers electrically coupled to the cathode and the anode.

15. The method of claim 14, wherein the power management electronic circuitry layers are formed on a first substrate and a microbattery stack comprising the Li-free cathode, the anode, and the electrolyte film are formed on a second substrate, and wherein the first and second substrates are bonded to each other on respective top surfaces thereof.

16. The method of claim 14, comprising forming the power management electronic circuitry layers and a microbattery stack comprising the Li-free cathode, the anode, and the electrolyte film on the same substrate.

17. The method of claim 16, comprising forming the electronic circuitry layers and the microbattery stack on the same side of the substrate or on opposite sides of the substrate.

18. (canceled)

19. The method of claim 11, comprising arranging current collection contacts for the Li-free cathode and the anode, respectively, at the same level.

20. The method of claim 11, wherein providing the anode comprises a bi-layer deposition of the semiconductor material and Li, respectively, and controlling a reaction between the semiconductor material and the Li for the lithiation, or wherein providing the anode comprises a multi-layer deposition of multiple layers of the semiconductor material and Li, respectively, and controlling a reaction between the semiconductor material and the Li for the lithiation.

21. (canceled)

22. The method of claim 11, wherein providing the anode comprises a co-deposition of the semiconductor material and Li for the lithiation.

23. A method of fabricating a microbattery array, comprising fabricating two or more Li-ion thin film microbatteries using the method of claim 11.
